(19) United States
(12) Patent Application Publication
(10) Pub. No.: US 2026/0161268 A1
(43) Pub. Date: Jun. 11, 2026

(54) PROMPT SUGGESTIONS WITH COMPATIBILITY INDICATORS FOR INTERACTING WITH A GENERATIVE APPLICATION

(71) Applicant: GOOGLE LLC, Mountain View, CA (US)

(72) Inventors: Ajay Prasad, Bangalore (IN); Ramprasad Sedouram, Bangalore (IN); Gulmohar Khan, Bangalore (IN)

(21) Appl. No.: 19/395,727

(22) Filed: Nov. 20, 2025

(30) Foreign Application Priority Data
Dec. 9, 2024 (IN) IN202411096994

(51) Int. Cl. G06F 3/0482; G06F 3/0486; G06F 40/166; G06T 11/00

(52) U.S. Cl. CPC G06F 3/0482; G06F 3/0486; G06F 40/166; G06T 11/00; G06T 2200/24

(57) ABSTRACT

Implementations set forth herein relate to a generative application that provides selectable suggestions for creating prompts that can be processed by the generative application for accurately creating generative content for a user. A selectable suggestion can be rendered with one or more features for indicating a compatibility of content of the selectable suggestion with an initial input that the user has provided to the selectable suggestion. The feature can therefore indicate whether the selectable suggestion will provide a more accurate output and/or consume less tokens or other resources than other suggestions. In some implementations, interacting with a selectable suggestion can cause the feature to be exhibited, such as in response to an input gesture to a touch display or other interface.

### BACKGROUND

Humans may engage in human-to-computer dialogs with interactive software applications referred to herein as “automated assistants” (also referred to as “digital agents,” “chatbots,” “interactive personal assistants,” “intelligent personal assistants,” “assistant applications,” “conversational agents,” etc.). For example, humans (which when they interact with automated assistants may be referred to as “users”) may provide commands and/or requests to an automated assistant using spoken natural language input (i.e., utterances), which may in some cases be converted into text and then processed, and/or by providing textual (e.g., typed) natural language input.

In some instances, an automated assistant may provide access to a chat prompt for soliciting outputs from the automated assistant. However, this process can involve a number of iterations to refine the chat prompt depending on the experience of the user and/or availability of training data. For example, an assistant with limited training data may require a relatively large number of iterations to be completed before an accurate generative output is provided in response to an initial query from the user. These iterations can be computationally intense and waste resources at the local device, as well as any other affected device, such as at a cloud server. Although some generative applications may provide an archive of historical inquiries from the user, the archive may not be conducive to efficiently and/or more accurately processing novel inquiries from the user. In some instances, starting from a historical query may cause the generative application to provide generative output that is less accurate than if the user would have started with a more unique query. In such instances, a user would have no way of receiving feedback regarding whether involving the prior query would result in a generative output that is a more accurate response to a current query from the user to the assistant application. Having limited or no feedback in this regard can further exacerbate this issue of multiple unnecessary iterations being performed. This will in turn waste computational resources at any affected devices, such as a cloud processing service.

### SUMMARY

Implementations set forth herein relate to an automated assistant or generative application that provides selectable suggestions with features that indicate feedback regarding compatibility of each selectable suggestion to a current or estimated query or input from a user. Each selectable suggestion can be rendered at an interface with a prompt or field for receiving an input from the user to the automated assistant application. Each selectable suggestion can include content that is based on contextual data or other currently available data. In some implementations, the content can indicate how compatible the particular selectable suggestion is with the user's query and/or previously selected selectable suggestion(s) during a current session with the automated assistant, thereby guiding the human-to-computer interaction to a quick and efficient result while obviating the need for unnecessary iterations being performed and conserving computational resources.

For example, when the user initially accesses the application, the application can be rendered with one or more selectable GUI elements corresponding to the selectable suggestions. Alternatively, or additionally, the one or more selectable suggestions can be rendered in response to a partial input, or complete input, from the user to the assistant application in furtherance of causing the application to provide a generative output. Each selectable suggestion can be rendered with one or more features that indicate feedback for the user to consider before selecting a particular selectable suggestion. For example, a color or other style of a selectable suggestion can indicate a measure of compatibility relative to an input from the user to the assistant application. Based on the features rendered for the selectable suggestions, a user can select a particular selectable suggestion that is estimated to be most compatible with an input that the assistant application has already received, thereby reducing a chance for the automated assistant to generate erroneous output or unrelated output.

In some implementations, multiple different selectable suggestions can be selected by a user for processing as an input to a generative model. As the user interacts with one or more of the selectable suggestions, a feature of a selectable suggestion may change in response to how the user is interacting with the selectable suggestions. This change can indicate that the particular selectable suggestion is more compatible with a draft query that the user is constructing, or is less compatible with the draft query. A selectable suggestion may be determined to be less compatible with a combination of other selectable suggestions when, for example, adding that particular selectable suggestion to the query (e.g., the draft query compiled from the other selectable suggestions) would result in the consumption of tokens beyond a particular threshold, would result in non-sensical generative output, would not conform with the query, etc. Alternatively, or additionally, content of a selectable suggestion can be determined to be compatible with another selectable suggestion and/or an input query based on mappings of embeddings in a latent space. For example, content of a selectable suggestion for a query can be processed to generate an embedding that is mapped to a latent space. A distance (e.g., cosine distance, Euclidean distance, etc.) between that embedding and another embedding for a different selectable suggestion, or another embedding for the input, can be determined. When the distance between certain embeddings satisfies a threshold distance value, the selectable suggestion can be determined as compatible with another selectable suggestion or the input, and optionally to the extent of compatibility based on the distance. Alternatively, or additionally, compatibility between selectable suggestions and/or between other content provided by the generative application can be determined using one or more machine learning models and/or one or more heuristic processes.

In some implementations, features of a selectable suggestion can be dynamic and/or change according to how the user interacts with the generative application. For example, a dynamic feature can be exhibited as feedback in response to the user interacting with a selectable suggestion. For instance, the feedback can be a user perceived repulsion or attraction between selectable suggestions when a user is dragging and dropping a selectable suggestion GUI element towards another GUI element. In such instances, the GUI element can provide or exhibit feedback that indicates a resistance from being attached to another GUI element when compatibility between those GUI elements or selectable suggestions is relatively low. However, when the user is dragging a selectable suggestion GUI element towards another GUI element and those GUI elements are determined to be relatively compatible, those GUI elements may exhibit feedback as an apparent attraction towards each other. For example, a velocity or acceleration of the GUI element may increase or decrease in a trajectory that is towards or away from another GUI element, depending on a compatibility determined for the GUI element and other GUI element. As another example, haptic feedback or vibration of sensors of a computing device may increase or decrease in a trajectory that is towards or away from another GUI element, depending on a compatibility determined for the GUI element and other GUI element.

In some implementations, when a user provides an input to an input field, such as a text field, one or more selectable suggestions can be rendered with one or more features for indicating their compatibility with the input to the input field. In some implementations, a feature that is rendered can include a color, style, sound, or other output that can be rendered by a computing device. As one non-limiting example, a selectable suggestion can be rendered with a red trim when compatibility with the input is relatively low. Alternatively, another selectable suggestion can be rendered with a green trim when compatibility with the input is relatively high. In some implementations, as the user is providing additional input to the input field, a feature of the input field, and/or a feature of the input, can be adjusted according to a determined compatibility with the previous or existing input, one or more selectable suggestions, and/or one or more draft queries being created by the user to submit to the generative application.

As one illustrative example, the user can be accessing a generative application to generate text for a children's story. Initially, the user can provide an input to an input field of the generative application, requesting that the generative application provide a fictional children's story that teaches some aspects of botany. In response to the user providing at least a portion of this input to the input field, one or more selectable suggestions can be rendered at an application interface of a computing device. A feature of each respective selectable suggestion can include a color or style that is indicative of compatibility with the input. For example, content of a first selectable suggestion can include a portion of a query to append to the input from the user. The partial query can be, for example, “ . . . and make a table of contents with pictures that kids will enjoy.” This selectable suggestion can be rendered with a green boundary to indicate that it is compatible with the input from the user since children are generally receptive to pictures. A second selectable suggestion can also be rendered with content for a partial query, such as, “ . . . and be sure to include names of famous botanists throughout history.” This second selectable suggestion can be rendered with a feature such as a red trim to indicate that the second selectable suggestion is relatively less compatible with the input compared to the first selectable suggestion since children are generally less receptive to historical information relative to pictures.

In some implementations, each feature can be rendered with the particular feature because of its compatibility with the input, as well as its compatibility with any ongoing interactions with the automated assistant or generative application. For example, the user may have been interacting with the generative application over the course of a few days in different sessions, and in furtherance of finalizing the fictional children's story. Therefore, the context of the entire interaction regarding the children's story can be a basis for generating a feature for a selectable suggestion (with prior express permission from the user). For example, because the user may have been interacting with the assistant application to create a fictional children's story, the second selectable suggestion would be rendered with red trim because it corresponds to non-fictional persons (e.g., famous botanists throughout history). However, the second selectable suggestion may nonetheless be rendered because the generative application has determined that it may be important to this particular user and/or this particular interaction.

For example, other contextual data available to the automated assistant application (with prior permission from the user) can indicate that the user had recently been researching a famous botanist. This can provide for a more efficient interaction with the automated assistant, which can result in preservation of computational resources utilized to provide generative outputs. Furthermore, by filtering out selectable suggestions that do not have a threshold level of compatibility, computational resources can be further preserved as a user would be relying on more compatible inputs during a session with the automated assistant.

As described herein, a generative model can be any sequence-to-sequence based machine learning model capable of generating generative vision data, generative audio data, generative textual data, and/or other forms of generative data. Some non-limiting examples of sequence-to-sequence based machine learning models that are capable of generating one or more forms of the generative data noted above include transformer-based machine learning models (e.g., encoder-decoder transformer models, encoder-only transformer models, decoder-only transformer models, etc. that optionally employ an attention mechanism or some other form of memory), stable diffusion-based machine learning models, recurrent neural network-based machine learning models, generative adversarial network-based machine learning models, etc. Various sequence-to-sequence based machine learning models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.). Some particular non-limiting examples of these sequence-to-sequence based machine learning models that have demonstrated multimodal capabilities include the Gemini family of models, the ChatGPT family of models, the Claude family of models, the Llama family of models, and/or other families of sequence-to-sequence generative models.

The above description is provided as an overview of some implementations of the present disclosure. Further description of those implementations, and other implementations, are described in more detail below.

### BRIEF DESCRIPTION OF THE DRAWINGS

FIG. 1A, FIG. 1B, FIG. 1C, and FIG. 1D illustrate views of a user interacting with a generative application that provides selectable suggestions for assembling an input for receiving generative output.

FIG. 2 illustrates a system that provides access to an automated assistant or other generative application that can generate selectable suggestions with features that indicate compatibility with generative output and/or a user query for generative output.

FIG. 3 illustrates a method for providing prompt suggestions for a generative application and appending model inputs according to how a user interacts with the prompt suggestions.

FIG. 4 is a block diagram of an example computer system.

### DETAILED DESCRIPTION

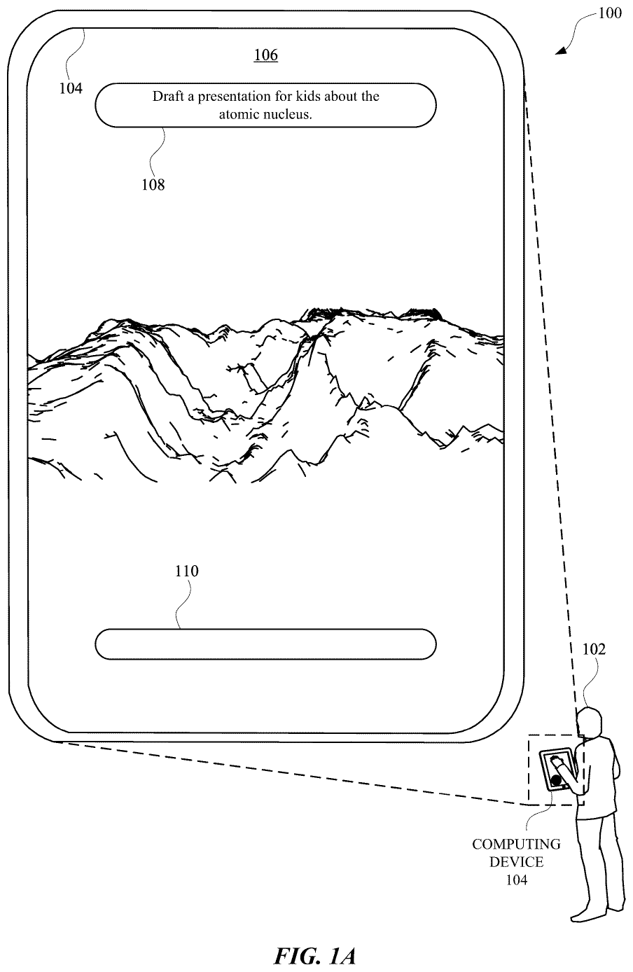

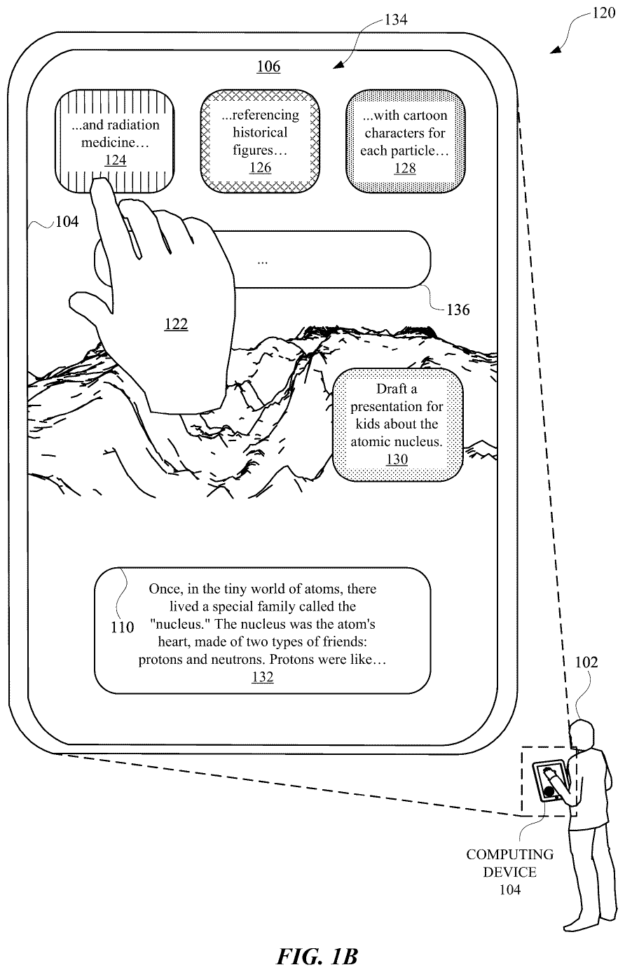

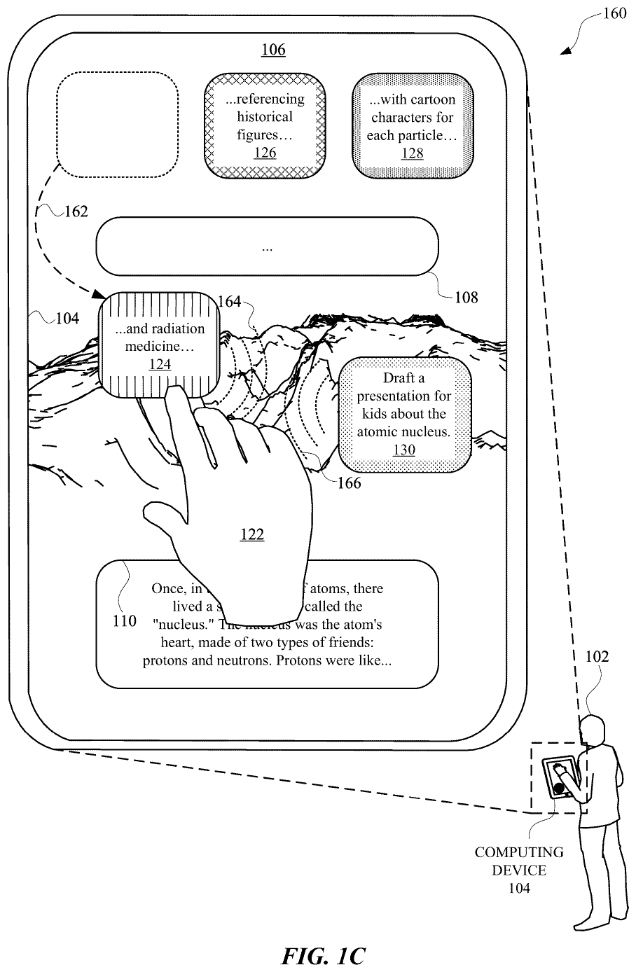

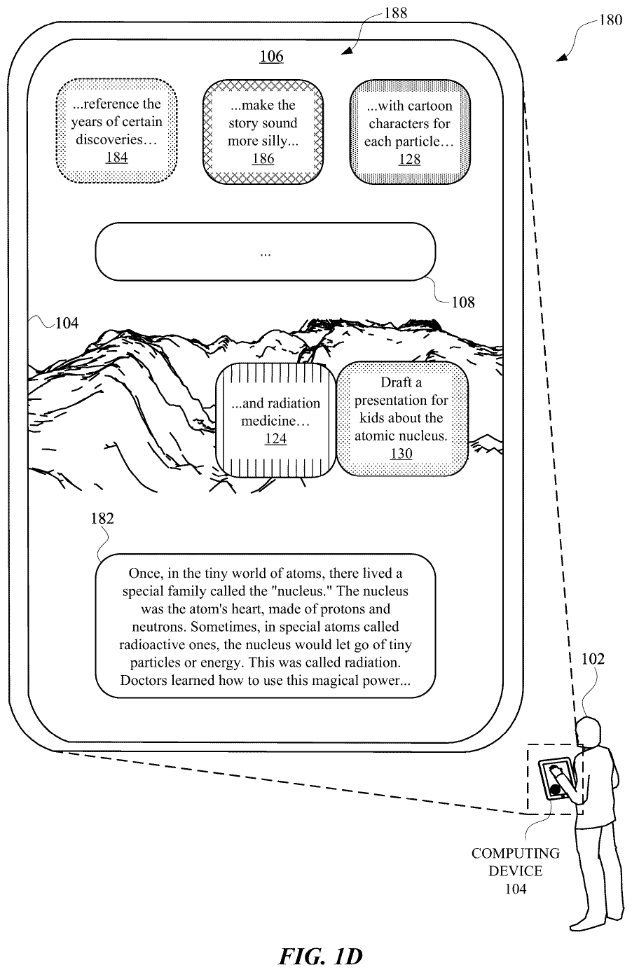

FIG. 1A, FIG. 1B, FIG. 1C, and FIG. 1D illustrate views 100, 120, 160, and 180, respectively, of a user 102 interacting with a generative application that provides selectable suggestions for assembling an input for receiving generative output. The generative application also adapts the selectable suggestions according to how the user 102 interacts with the selectable suggestions and/or any input received by the computing device 104. In some instances, the user 102 can be interacting with the computing device 104 and/or a generative application in furtherance of accessing or receiving generative output that is generated using a generative model. The user 102 can provide an input 108 at an interface 106 of computing device 104 and, in response, the generative application can provide an output at an output field 110. For example, the user 102 can type an input 108, “Draft a presentation for kids about the atomic nucleus”, as shown in view 100 of FIG. 1A.

In response to receiving the input 108, generative application can generate an output 132 that is generated using one or more generative models, as shown in view 120 of FIG. 1B. In some implementations, the generative application can cause one or more selectable suggestions 134 to be rendered at an interface 106 of the computing device 104 with or without receiving the input 108. In some implementations, the selectable suggestions 134 can be rendered upon entry into the generative application, in response to the input 108, and/or otherwise based on processing contextual data associated with the user 102 (with prior express permission from the user 102). The selectable suggestions 134 can be selected by the user 102 to prompt the generative application to generate the output 132. In this way, the output 132 can be more accurately generated for the user 102 while minimizing the number of inputs received from the user 102. This can guide the human-to-computer dialog and improve computational efficiency at the computing device 104 (and/or a remote system in communication with the computing device 104), thereby conserving computational resources for any associated devices and/or applications.

For example, in response to receiving the input 108, the generative application can cause one or more selectable suggestions 134 to be rendered at the display interface 106, and each of the selectable suggestions 134 can be selected by the user 102. In some implementations, the generative application can cause an initial selection 130 to be rendered at the display interface 106, and the initial selection 130 can optionally be based on the input 108. The initial selection 130 can reflect the input 108 from the user 102, thereby allowing the user 102 to interact with the selectable suggestions 134 and compile a modified input. For example, upon viewing the output 132, the user 102 can determine whether to provide additional input to the generative application in furtherance of refining the output 132. Accordingly, it should be understood that the one or more selectable suggestions being rendered after the output 132 is generated and rendered is not meant to be limiting, such that the initial suggestion 130 and the one or more selectable suggestions 134 can be considered prompt units that are selected to be combined together to generate the input 108 that is applied to a generative model.

In some implementations, the selectable suggestions 134 can be rendered with one or more features that indicate certain properties of the selectable suggestions 134. For example, a feature of a respective selectable suggestion can indicate a compatibility with the respective selectable suggestion. For instance, the compatibility can be based on one or more compatibility metrics that can be determined based on a distance between embeddings in a latent space. The distance between the embeddings in the latent space can indicate a relevance of the content that served as the basis for generating different embeddings. In some instances, an embedding can be generated based on the output 132 and/or the content of the initial selection 130, and another embedding can be generated based on a candidate suggestion. When a distance (e.g., cosine distance, Euclidean distance, etc.) between these embeddings satisfies a threshold value, the candidate suggestion can be selected to be presented as a selectable suggestion 134. This distance can also be the basis for one or more features that are rendered for one of the selectable suggestions 134.

In some implementations, one or more machine learning models can be utilized to determine whether to provide a particular selectable suggestion, and one or more other models can be utilized to determine one or more features to render for a particular selectable suggestion. For example, one or more features rendered for a first selectable suggestion 124 can indicate a difference between processing initial suggestion with the first selectable suggestion 124 compared to processing the initial selection 130 with a second selection suggestion 126 and/or a third selectable suggestion 128. In some instances, the feature can indicate that processing an input with a respective selectable suggestion will result in consumption of more tokens or less tokens than processing the input with a different selectable suggestion. In some instances, the feature can indicate that processing an input with a respective selectable suggestion will result in an output that is more related to the initial selection 130, the output 132, and/or contextual data associated with the user 102 (accessed with prior express permission from the user 102). This determination can be made using one or more trained machine learning models (e.g., a more computationally efficient generative model, a classifier, etc.) and/or one or more heuristic processes.

As one non-limiting example, a visual feature rendered for each of the one or more selectable suggestions 134 can appear different based on the initial selection 130 and/or contextual data associated with the user 102. For example, the initial selection 130 can be rendered with a feature such as a particular color, pattern, and/or other feature that can be rendered with a selectable suggestion or other graphical element. Each of the selectable suggestions can also be rendered with a particular feature that can indicate compatibility with the feature of the initial selection 130. For example, the third selectable suggestion 128 can be rendered with a particular feature that indicates the third selectable suggestion is most compatible with the initial selection 130, at least relative to the other selectable suggestions. The third selectable suggestion 128 can be rendered with this feature because of the user 102 having previously interacted with the generative application to provide generative output associated with children's books.

Alternatively, the first selectable suggestion 124 and the second selectable suggestion 126 can be rendered with their own respective features that are distinguished from the feature rendered with the initial selection 130. These distinguishing features can be based on determined relevance of the content of those selectable suggestions compared to the content of the initial selection 130. For example, the content of the first selectable suggestion 124 can be related to the initial selection 130, but the one or more features rendered with the first selectable suggestion 124 can appear slightly different than the one or more other features of the initial selection 130. These differences in features can indicate to the user 102 that combining that content may result in generative output that may not be preferable to the user 102 and/or may otherwise not be conducive to efficient output generation. In some implementations, the user 102 can perform a gesture or otherwise provide an input for selecting a selectable suggestion to create a draft query for the generative application with the initial selection 130. The gesture can be performed by a hand 122 of the user 102 (or other extremity of the user 102 or input device of the computing device 104 (e.g., a mouse, a stylus, etc.)) via an interface of the computing device 104. Alternatively, or additionally, the user 102 can provide an additional input to an input field 136 of the generative application in order to draft an input query for the generative application or otherwise combine a selectable suggestion with the initial selection 130.

For example, as illustrated in view 160 of FIG. 1C, the user 102 can provide a gesture input to cause the first selectable suggestion 124 to be relocated 162 from a first position at the display interface 106 to a second position that is more proximate to the initial selection 130 GUI element. In some implementations, a feature that is rendered by the generative application can be a response to this gesture from the user 102. The response can be indicative of a compatibility of the first selectable suggestion 124 with the initial selection 130. This responsive feature can be dynamic as the user 102 performs the gesture. For example, a response feature 164 of the first selectable suggestion 124 and/or another response 166 of the initial selection 130 can be apparent at one or more interfaces of the computing device 104. The responsive feature can be an apparent attraction and/or an apparent repulsion of the first selectable suggestion or the initial selection 130. However, despite the repulsion or attraction of the two GUI elements, the user 102 can nonetheless complete the gesture that causes the first selectable suggestion 124 to be combined with the initial selection 130 as a draft query for the generative application. In some implementations, a degree to which the feature is exhibited can be proportional to or otherwise based on a value for a compatibility metric. For example, when a compatibility metric is particularly high or low, an amount of repulsion or attraction that is exhibited by the first selectable suggestion 124 during the gesture can be also relatively high or low. In some implementations, an amount of repulsion or an amount of attraction can be exhibited or detected at one or more interfaces of the computing device 104. For example, a haptic output, visual output, and/or audio output can be indicative of an amount of repulsion and/or an amount of attraction exhibited by the first selectable suggestion 124 and/or the initial selection 130 before, during, and/or after the user 102 performs a gesture.

In response to the user 102 performing the gesture, and/or based on the draft query being processed, the generative application can provide a modified output 182, as shown in view 180 of FIG. 1D. The modified output can be generated by one or more generative models using the content of the first selectable suggestion 124 and/or the initial selection 130. The modified output 182 can be a basis for content of updated selectable suggestions 188. For example, in response to the user 102 performing the gesture, the generative application can render an updated first selectable suggestion 184, and a second updated selectable suggestion 186. These updated selectable suggestions 188 can be subject to another gesture performed by the user 102 in furtherance of further amending their query to the generative application. Alternatively, or additionally, the user 102 can provide another input to the input field 108 in furtherance of amending or otherwise modifying the query to the generative application.

In some implementations, the updated selectable suggestions 188 can be generated based on the current interaction between the user 102 and the generative application, any prior interactions between the user 102 and the generative application, and/or interactions between other users and other generative applications, with prior permission from any associated users. Alternatively, or additionally, features of each of the respective updated selectable suggestions 188 can be rendered based on compatibility of each updated selectable suggestion with the updated output 182, the modified query, and/or any other contextual data associated with the user 102 and/or the generative application. Alternatively, or additionally, any selectable suggestion that was already present can be regenerated with an updated feature that indicates an updated compatibility metric. In this way, the user 102 can be on notice of any updated relevance or compatibility between a selectable suggestion, whether newly generated or not, and any generative output and/or modified query. In some implementations, and with prior expressed permission from any affected users, the user 102 can share the query and/or selectable suggestions with any other users via the generative application and/or any other associated application. For example, the generative application can be associated with a software platform through which users can trade queries that they create and/or selectable suggestions that arise during interactions with the generative application.

Similar to as noted above, it should be understood that the first selectable suggestion 124 can be combined with the initial selection 130 as a draft query for the generative application without causing any output (e.g., the modified output 182) to be generated, such that the first selectable suggestion 124 can be combined with the initial selection 130 can be considered prompt units that are selected to be combined as an eventual input that is applied to a generative model. For example, the user 102 can continue adding one or more of the selectable suggestions 134 and/or one or more of the updated selectable suggestions 188. Further, the user 102 can remove one or more of the selectable suggestions 134 and/or one or more of the updated selectable suggestions 188 after they have been added. Accordingly, no output may be generated until the user 102 indicates that an input is completed.

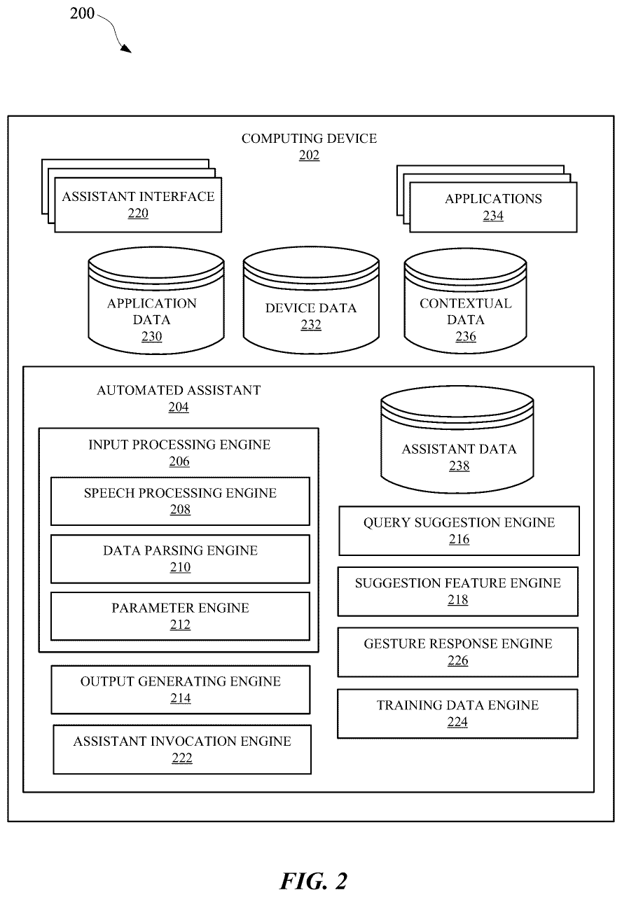

FIG. 2 illustrates a system 200 that provides access to an automated assistant 204 or other generative application that can generate selectable suggestions with features that indicate compatibility with anticipated or expected generative output and/or a user query for generative output. For example, the automated assistant 204 can operate as part of an assistant application that is provided at one or more computing devices, such as a computing device 202 and/or a server device. A user can interact with the automated assistant 204 via assistant interface(s) 220, which can be a microphone, a camera, a touch screen display, a user interface, and/or any other apparatus capable of providing an interface between a user and an application. For instance, a user can initialize the automated assistant 204 by providing a verbal, textual, and/or a graphical input to an assistant interface 220 to cause the automated assistant 204 to initialize one or more actions (e.g., provide data, control a peripheral device, access an agent, generate an input and/or an output, etc.). Alternatively, the automated assistant 204 can be initialized based on processing of contextual data 236 using one or more trained machine learning models. The contextual data 236 can characterize one or more features of an environment in which the automated assistant 204 is accessible, and/or one or more features of a user that is predicted to be intending to interact with the automated assistant 204. The computing device 202 can include a display device, which can be a display panel that includes a touch interface for receiving touch inputs and/or gestures for allowing a user to control applications 234 of the computing device 202 via the touch interface. In some implementations, the computing device 202 can lack a display device, thereby providing an audible user interface output, without providing a graphical user interface output. Furthermore, the computing device 202 can provide a user interface, such as a microphone, for receiving spoken natural language inputs from a user. In some implementations, the computing device 202 can include a touch interface and can be void of a camera, but can optionally include one or more other sensors.

The computing device 202 and/or other third party client devices can be in communication with a server device over a network, such as the internet. Additionally, the computing device 202 and any other computing devices can be in communication with each other over a local area network (LAN), such as a Wi-Fi network. The computing device 202 can offload computational tasks to the server device in order to conserve computational resources at the computing device 202. For instance, the server device can host the automated assistant 204 or a generative model, and/or computing device 202 can transmit inputs received at one or more assistant interfaces 220 to the server device. However, in some implementations, the automated assistant 204 or generative model can be hosted at the computing device 202, and various processes that can be associated with automated assistant operations can be performed at the computing device 202 (e.g., on-device processing using a generative model).

In various implementations, all or less than all aspects of the automated assistant 204 can be implemented on the computing device 202. In some of those implementations, aspects of the automated assistant 204 are implemented via the computing device 202 and can interface with a server device, which can implement other aspects of the automated assistant 204. The server device can optionally serve a plurality of users and their associated assistant applications via multiple threads. In implementations where all or less than all aspects of the automated assistant 204 are implemented via computing device 202, the automated assistant 204 can be an application that is separate from an operating system of the computing device 202 (e.g., installed “on top” of the operating system)—or can alternatively be implemented directly by the operating system of the computing device 202 (e.g., considered an application of, but integral with, the operating system).

In some implementations, the automated assistant 204 can include an input processing engine 206, which can employ multiple different modules for processing inputs and/or outputs for the computing device 202 and/or a server device. For instance, the input processing engine 206 can include a speech processing engine 208, which can process audio data received at an assistant interface 220 to identify the text embodied in the audio data. The audio data can be transmitted from, for example, the computing device 202 to the server device in order to preserve computational resources at the computing device 202. Additionally, or alternatively, the audio data can be exclusively processed at the computing device 202.

The process for converting the audio data to text can include a speech recognition algorithm, which can employ neural networks, and/or statistical models for identifying groups of audio data corresponding to words or phrases. The text converted from the audio data can be parsed by a data parsing engine 210 and made available to the automated assistant 204 as textual data that can be used to generate and/or identify command phrase(s), intent(s), action(s), slot value(s), and/or any other content specified by the user. In some implementations, output data provided by the data parsing engine 210 can be provided to a parameter engine 212 to determine whether the user provided an input that corresponds to a particular intent, action, and/or routine capable of being performed by the automated assistant 204 and/or an application or agent that is capable of being accessed via the automated assistant 204. For example, assistant data 238 can be stored at the server device and/or the computing device 202, and can include data that defines one or more actions capable of being performed by the automated assistant 204, as well as parameters necessary to perform the actions. The parameter engine 212 can generate one or more parameters for an intent, action, and/or slot value, and provide the one or more parameters to an output generating engine 214. The output generating engine 214 can use the one or more parameters to communicate with an assistant interface 220 for providing an output to a user, and/or communicate with one or more applications 234 for providing an output to one or more applications 234.

In some implementations, the automated assistant 204 can be an application that can be installed “on-top of” an operating system of the computing device 202 and/or can itself form part of (or the entirety of) the operating system of the computing device 202. The automated assistant application includes, and/or has access to, on-device speech recognition, on-device natural language understanding, and on-device fulfillment. For example, on-device speech recognition can be performed using an on-device speech recognition module that processes audio data (detected by the microphone(s)) using an end-to-end speech recognition machine learning model stored locally at the computing device 202. The on-device speech recognition generates recognized text for a spoken utterance (if any) present in the audio data. Also, for example, on-device natural language understanding (NLU) can be performed using an on-device NLU module that processes recognized text, generated using the on-device speech recognition, and optionally contextual data, to generate NLU data. However, in various implementations, one or more of on-device speech recognition, on-device natural language understanding, and/or on-device fulfillment can be replaced with an on-device generative model that has multi-modal capabilities as described herein.

NLU data can include intent(s) that correspond to the spoken utterance and optionally parameter(s) (e.g., slot values) for the intent(s). On-device fulfillment can be performed using an on-device fulfillment module that utilizes the NLU data (from the on-device NLU), and optionally other local data, to determine action(s) to take to resolve the intent(s) of the spoken utterance (and optionally the parameter(s) for the intent). This can include determining local and/or remote responses (e.g., answers) to the spoken utterance, interaction(s) with locally installed application(s) to perform based on the spoken utterance, command(s) to transmit to internet-of-things (IoT) device(s) (directly or via corresponding remote system(s)) based on the spoken utterance, and/or other resolution action(s) to perform based on the spoken utterance. The on-device fulfillment can then initiate local and/or remote performance/execution of the determined action(s) to resolve the spoken utterance.

In various implementations, remote speech processing, remote NLU, and/or remote fulfillment can at least selectively be utilized. For example, recognized text can at least selectively be transmitted to remote automated assistant component(s) for remote NLU and/or remote fulfillment. For instance, the recognized text can optionally be transmitted for remote performance in parallel with on-device performance, or responsive to failure of on-device NLU and/or on-device fulfillment. However, on-device speech processing, on-device NLU, on-device fulfillment, and/or on-device execution can be prioritized at least due to the latency reductions they provide when resolving a spoken utterance (due to no client-server roundtrip(s) being needed to resolve the spoken utterance). Further, on-device functionality can be the only functionality that is available in situations with no or limited network connectivity. However, in various implementations, one or more of remote speech processing, remote NLU, and/or remote fulfillment can be replaced with a remote generative model that has multi-modal capabilities as described herein.

In some implementations, the computing device 202 can include one or more applications 234 which can be provided by a third-party entity that is different from an entity that provided the computing device 202 and/or the automated assistant 204. An application state engine of the automated assistant 204 and/or the computing device 202 can access application data 230 to determine one or more actions capable of being performed by one or more applications 234, as well as a state of each application of the one or more applications 234 and/or a state of a respective device that is associated with the computing device 202. A device state engine of the automated assistant 204 and/or the computing device 202 can access device data 232 to determine one or more actions capable of being performed by the computing device 202 and/or one or more devices that are associated with the computing device 202. Furthermore, the application data 230 and/or any other data (e.g., device data 232) can be accessed by the automated assistant 204 to generate contextual data 236, which can characterize a context in which a particular application 234 and/or device is executing, and/or a context in which a particular user is accessing the computing device 202, accessing an application 234, and/or any other device or module.

While one or more applications 234 are executing at the computing device 202, the device data 232 can characterize a current operating state of each application 234 executing at the computing device 202. Furthermore, the application data 230 can characterize one or more features of an executing application 234, such as content of one or more graphical user interfaces being rendered at the direction of one or more applications 234. Alternatively, or additionally, the application data 230 can characterize an action schema, which can be updated by a respective application and/or by the automated assistant 204, based on a current operating status of the respective application. Alternatively, or additionally, one or more action schemas for one or more applications 234 can remain static, but can be accessed by the application state engine in order to determine a suitable action to initialize via the automated assistant 204.

The computing device 202 can further include an assistant invocation engine 222 that can use one or more trained machine learning models to process application data 230, device data 232, contextual data 236, and/or any other data that is accessible to the computing device 202. The assistant invocation engine 222 can process this data in order to determine whether or not to wait for a user to explicitly speak an invocation phrase to invoke the automated assistant 204, or consider the data to be indicative of an intent by the user to invoke the automated assistant—in lieu of requiring the user to explicitly speak the invocation phrase. For example, the one or more trained machine learning models can be trained using instances of training data that are based on scenarios in which the user is in an environment where multiple devices and/or applications are exhibiting various operating states. The instances of training data can be generated in order to capture training data that characterizes contexts in which the user invokes the automated assistant and other contexts in which the user does not invoke the automated assistant. When the one or more trained machine learning models are trained according to these instances of training data, the assistant invocation engine 222 can cause the automated assistant 204 to detect, or limit detecting, spoken invocation phrases from a user based on features of a context and/or an environment. Additionally, or alternatively, the assistant invocation engine 222 can cause the automated assistant 204 to detect, or limit detecting for one or more assistant commands from a user based on features of a context and/or an environment. In some implementations, the assistant invocation engine 222 can be disabled or limited based on the computing device 202 detecting an assistant suppressing output from another computing device. In this way, when the computing device 202 is detecting an assistant suppressing output, the automated assistant 204 will not be invoked based on contextual data 236—which would otherwise cause the automated assistant 204 to be invoked if the assistant suppressing output was not being detected.

In some implementations, the system 200 can include a query suggestion engine 216 that can generate content for query suggestions (e.g., selectable suggestions, prompt suggestions, etc.). The query suggestions can be generated upon opening the application and/or in response to a user providing an input to the application. For example, the contextual data 236 or other data can be utilized by the automated assistant 204 and/or other generative application to generate content for rendering of multiple different selectable suggestions. In some implementations, the system 200 can include a suggestion feature engine 218. The suggestion feature engine 218 can process contextual data 236 and/or other data to determine one or more features for each selectable suggestion. In some implementations, each feature can be the same, or different, for each respective selectable suggestion, and the feature can vary depending on a determined compatibility of a corresponding selectable suggestion with a generative output, draft query, and/or other input from the user. In some implementations, content data received from the query suggestion engine 216 can be processed to determine each respective feature to render in association with each respective selectable suggestion.

In some implementations, the system 200 can include a gesture response engine 226. The gesture response engine 226 can be an optional engine that can provide feedback to the user before, during, and/or after the user interacts with a generative application. For example, when the user interacts with a particular selectable suggestion, the gesture response engine 226 can determine the particular selectable suggestion that the user is interacting with and provide feedback accordingly. In some implementations, the feedback that is provided can be based on a feature that is rendered with a particular selectable suggestion. Alternatively, or additionally, the gesture response engine 226 can cause feedback to be rendered for a user based on data provided by the suggestion feature engine 218, but not rendered as a feature until the user interacts with the corresponding selectable suggestion. For example, a user can perform a drag-and-drop operation (e.g., using a touch interface, peripheral device, non-touch gesture, etc.) at a particular selectable suggestion and, in response, the gesture response engine 226 can cause the particular selectable suggestion to exhibit a feature, such as an amount of repulsion and/or an amount of attraction. This feature can be exhibited as the user performs the drag-and-drop operation or other gesture, thereby putting the user on notice of any determined compatibility of the particular selectable suggestion with an input from the user, generative content, and/or another portion of the application.

In some implementations, as the user interacts with each selectable suggestion, a training data engine 224 can generate training data. The training data can characterize a feature of a selectable suggestion that a user interacted with for a particular input from the user (e.g., using this interaction as feedback for use in reinforcement learning from human feedback (RLHF)). Alternatively, or additionally, the training data can characterize content of a selectable suggestion that the user interacted with for a particular input from the user. In this way, models can be further trained based on this training data. Those updated models can then be utilized to provide more accurate and/or more useful content for prompt suggestions, and/or more informative features for those prompt suggestions. This can improve the efficiency of the generative application by reducing a number of query iterations processed before providing generative content that is suitable for a user. This can also reduce the waste of resources (e.g., network bandwidth, network memory, power, etc.) that might otherwise be consumed processing queries formed from incompatible prompts and/or other incompatible inputs.

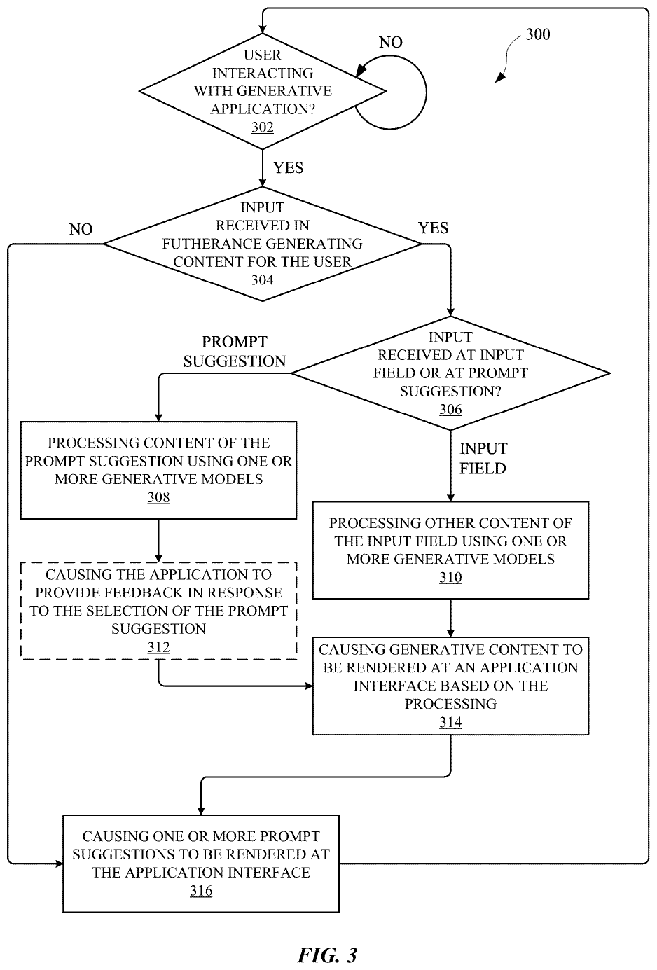

FIG. 3 illustrates a method 300 for providing prompt suggestions for a generative application and appending model inputs according to how a user interacts with the prompt suggestions. A prompt suggestion can be provided upon entry to the application and/or generated based on an input or partial input to the application. The method 300 can be performed by one or more applications, computing devices, and/or any other apparatus or module capable of interacting with an automated assistant. The method 300 can include an operation 302 for determining whether the user is interacting with a generative application. When the user is determined to be interacting with the generative application, the method 300 can proceed from the operation 302 to an operation 304. An interaction with the generative application can include opening the generative application, interacting with the generative application once opened, and/or any other direct or indirect interaction with content associated with the generative application.

The operation 304 can include determining whether an input has been received in furtherance of generating content for the user. The input can be, for example, a typed input to a field of the generative application, a selection of a GUI element at the generative application, or any other input that can be received by the application via an interface of a computing device. For example, the user may have typed in a request for the generative application to create a story from a few subjects in physics. This typed input can be received at an input field of an application interface of the generative application. In response to receiving an input, or otherwise determining an input was received, the method 300 can proceed from the operation 304 to an operation 306. However, if no input is received for a threshold amount of time or otherwise (or if no further input is received for a threshold amount of time or otherwise if a partial input has been received), the method 300 can proceed from the operation 304 to an operation 316 (which is described in more detail below).

The operation 306 can include determining whether the input was received at an input field or at a prompt suggestion. A prompt suggestion can refer to one or more features of the application that suggest prompts for a user to implement in a request for generative content. For example, when the user opens the generative application, one or more different prompt suggestions can optionally be rendered at the application interface. The user can select one of the prompt suggestions via input to an interface of the application or computing device. A prompt suggestion can be, for example, based on prior interactions between the user and the generative application, based on a database of prompts from the user and/or other users, and/or other contextual data associated with the user and/or the generative application. For instance, the user may have previously provided input related to physics during a prior session with the generative application. Based on this context, and with prior permission from the user, prompt suggestions can be rendered with content for appending or modifying a prompt that could be processed by the one or more generative models to generate physics-related content. However, in some instances, although the initial prompt suggestions may be associated with the user, or otherwise relevant in some contexts, the prompt suggestions may or may not be initially relevant to whatever input the user has initially provided upon accessing the generative application.

When the user is determined to have provided an input to the input field of the generative application, the method 300 can proceed from the operation 306 to an operation 310. Otherwise, when the input is determined to be a selection of a prompt suggestion, the method 300 can proceed from the operation 306 to an operation 308. The operation 308 can include processing content of the prompt suggestion using one or more generative models. The content can be processed in furtherance of providing generative content for the user who selected the particular prompt suggestion. In some instances, other available data may be processed with the content in furtherance of generating the generative content. The operation 310 can include causing other content of the input field to be processed using one or more generative models. This other content of the input field can also be processed in furtherance of providing generative content for the user that provided the input to the input field.

In some implementations, the method 300 can proceed from the operation 308 to an operation 312. The operation 312 can be an optional operation that includes causing the application to provide feedback in response to the selection of the prompt suggestion. The feedback can indicate a compatibility of the prompt suggestion to an existing input or partial input, and/or existing generative content. In some implementations, when a prompt suggestion is rendered as a GUI element, a selection of the particular prompt suggestion can cause the GUI element to exhibit a feature, such as a dynamic feature, that indicates a degree to which the particular prompt suggestion is related or unrelated to existing generative content and/or a received input. In some implementations, the user may perform a drag-and-drop operation, highlight operation, or any other suitable operation for causing the selected prompt suggestion to be appended to an existing draft input prompt. In such instances, the feedback provided by the application can be visual feedback, haptic feedback, audible feedback, and/or any other feedback that can give the impression that the GUI element being selected is a feature. The GUI element is attracted to or not attracted to the existing draft input or existing generative content.

The method 300 can proceed from the operation 312 and/or the operation 310 to an operation 314. The operation 314 can include causing generative content to be rendered at an application interface based on the processing. For example, in furtherance of the previous scenario mentioned, a user typing an input soliciting text of a story related to physics can result in generative textual content being provided by the generative application. This textual content may characterize a fictional story related to certain concepts in physics. Alternatively, when the processed content is based on one or more selected prompt suggestions, the generative content can be text or an image or another type of content that is related to the one or more selected prompt suggestion (and optionally any input that was received and/or other contextual data).

The method 300 can proceed from the operation 314 to an operation 316. The operation 316 can include causing one or more selectable suggestions to be rendered at an interface of the generative application based on the generative content provided by the generative application. In some implementations, each prompt suggestion can be rendered as a GUI element that the user can interact with to construct another prompt to be processed by one or more generative models. These one or more suggestions can replace any one or more existing prompt suggestions (e.g., selectable suggestions) rendered by the application interface and/or be included with any existing prompt suggestions already rendered by the generative application. For example, existing prompt suggestions may be related to physics, but not necessarily fictional stories involving physics. Therefore, in response to the user requesting generative content regarding a fictional story about certain aspects of physics, one or more prompt suggestions can be rendered pursuant to the operation 316. These additional prompt suggestions can replace the existing prompt suggestions and include content related to fictional stories.

For example, one or more selectable suggestions can be provided with respective content that is compatible with or otherwise related to the generative content provided by the generative application. In some implementations, a selectable suggestion is provided in furtherance of improving a query to be processed by the generative application. In some implementations, each selectable suggestion or the content thereof can be processed, or at least partially processed, with the initial input or other input from the user prior to the user selecting a selectable suggestion. Based on this processing, one or more selectable suggestions can be filtered out, and/or content of the selectable suggestions can be filtered out, and ultimately not suggested unless the processing results content satisfying one or more metrics. Alternatively, or additionally, certain content of certain selectable suggestions may not be processed with an initial input or other user input until the user selects the corresponding selectable suggestion. In this way, an initial query or modified query may not be processed using one or more models until a user affirmatively confirms that they would like the modified query to be processed.

The method 300 can proceed from the operation 316 and return to the operation 302, or any other suitable operation. By returning to the operation 302, an interaction with the generative application can be identified in furtherance of updating the application interface and/or content generated by the generative application. For example, one or more features rendered for a selectable suggestion can be modified or otherwise updated to reflect compatibility of the selectable suggestion with recently generated content. In this way, the user can remain on notice of any selectable suggestions that might result in generative content that is more accurate and/or more responsive to an initial input from the user.

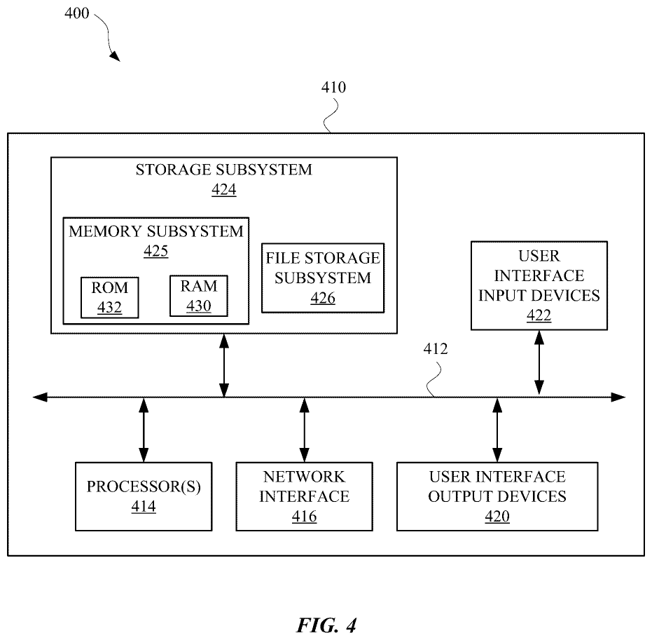

FIG. 4 is a block diagram 400 of an example computer system 410. Computer system 410 typically includes at least one processor 414 which communicates with a number of peripheral devices via bus subsystem 412. These peripheral devices may include a storage subsystem 424, including, for example, a memory 425 and a file storage subsystem 426, user interface output devices 420, user interface input devices 422, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, the storage subsystem 424 may include the logic to perform selected aspects of method 300, and/or to implement one or more of system 200, computing device 104, automated assistant, and/or any other application, device, apparatus, and/or module discussed herein.

These software modules are generally executed by processor 414 alone or in combination with other processors. Memory 425 used in the storage subsystem 424 can include a number of memories including a main random access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In some implementations, a method implemented by processor(s) is provided and includes receiving an input at an application interface that is being rendered by a computing device that provides access to an application. The input is provided in furtherance of causing the application to output generative content using one or more generative models. The method further includes determining, based on the input at the application interface, prompt suggestions to suggest for processing with the input to generate the generative content. The prompt suggestions are determined using the one or more generative models and/or one or more other models. The method further includes causing the application to render one or more graphical user interface (GUI) elements that characterize multiple different prompt suggestions of the prompt suggestions. Each GUI element of the one or more GUI elements is selectable via an additional input at the application interface of the computing device. The method further includes determining that a user has selected a particular prompt suggestion of the prompt suggestions via the application interface of the computing device. The application interface provides an indication that the user selected the particular prompt suggestion for processing with the input received at the application interface. The method further includes causing the application to output the generative content based on at least the particular prompt suggestion and the input received at the application interface.

These and other implementations of technology disclosed herein can optionally include one or more of the following features.

In some implementations, determining the prompt suggestions can include: determining a compatibility metric for the particular prompt suggestion based on a degree of compatibility between the input and the particular prompt suggestion. A particular GUI element for the particular prompt suggestion can be rendered with a feature that is based on the compatibility metric.

In some versions of those implementations, determining the compatibility metric for the particular prompt suggestion can include determining a degree of compatibility by comparing embedding classifiers generated for the input and the particular prompt suggestion. The compatibility metric can be based on the degree of compatibility.

In additional or alternative versions of those implementations, the feature can be a visual feature, and, when the compatibility metric satisfies a threshold value, the visual feature can appear visibly different from another feature of another GUI element of the one or more GUI elements rendered at the application interface.

In additional or alternative versions of those implementations, the feature can be a dynamic feature exhibited by the particular GUI element, or a device interface, when the user interacts with the application interface to cause the particular prompt suggestion to be processed with the input.

In some of those additional or alternative versions of those implementations, the dynamic feature can be a positive or negative attraction to an input GUI element, and the dynamic feature can be exhibited when the input is received at the application interface.

In some further of those additional or alternative versions of those implementations, the degree of attraction can be exhibited by the particular GUI element when the user performs a drag-and-drop gesture to change a proximity of the particular GUI element relative to the input GUI element.

In some other of those additional or alternative versions of those implementations, the input GUI element can be an available prompt suggestion provided by the application and selected by the user, and the input can be received when the user selects the available prompt suggestion by interacting with the interface of the computing device.

In some implementations, causing the application to output the generative content can include causing the application interface to include an interactive GUI element for adjusting a degree to which the particular prompt suggestion affects the generative content.

In some implementations, the method can further include causing an updated feature of a separate prompt suggestion of the prompt suggestions to be rendered based on the user selecting the particular prompt suggestion. The updated feature for the separate prompt suggestion can indicate a degree of compatibility of the separate prompt suggestion to the generative content.

In some versions of those implementations, the input can correspond to a generative text output and the particular prompt suggestion can correspond to a generative image output. Further, the updated feature can indicate that the separate prompt suggestion is compatible with a generative image or generative text.

In some further versions of those implementations, the method can further include causing the application to provide an initial generative image at the application interface in response to receiving the input. Causing the generative content to be output by the application can include modifying the initial generative image to be generative content that is based on the particular prompt suggestion and the input.

In some implementations, a method implemented by processor(s) is provided and includes receiving a partial input at an application interface that is being rendered by a computing device that provides access to an application. The partial input is provided in furtherance of causing the application to output generative content using one or more generative models. The method further includes causing the application to render one or more graphical user interface (GUI) elements that characterize multiple different prompt suggestions to add to the partial input. Each GUI element of the one or more GUI elements is selectable via an additional input at the application interface of the computing device. The method further includes determining that a user has selected a particular prompt suggestion of the prompt suggestions via the application interface of the computing device; determining whether the particular prompt suggestion is compatible with the partial input; and in response to determining that the particular prompt suggestion is not compatible with the partial input: generating a notification that indicates the particular prompt suggestion is not compatible with the partial input; and causing the application to output the notification in response to the user selecting the particular prompt suggestion.

These and other implementations of technology disclosed herein can optionally include one or more of the following features.

In some implementations, the method can further include, in response to determining that the particular prompt suggestion is not compatible with the partial input: causing the application to output the generative content based on at least the particular prompt suggestion and the partial input received at the application interface.

In some implementations, determining whether the particular prompt suggestion is compatible with the partial input can include: processing the particular prompt suggestion and the partial input using one or more of the generative models to determine whether the particular prompt suggestion and the partial input are compatible; and determining, based on the output, whether the particular prompt suggestion is compatible with the partial input.

In some implementations, determining whether the particular prompt suggestion is compatible with the partial input can include: causing a classifier, that is in addition to or included in the one or more generative models, to generate output based on processing the particular prompt suggestion and the partial input. Compatibility can be determined based on the output.

In some implementations, a method implemented by processor(s) is provided and includes determining that a user has accessed an application at a computing device that provides access to the application. The application provides access to one or more generative models. The method further includes causing the application to render one or more graphical user interface (GUI) elements that characterize multiple different prompt suggestions. Each GUI element of the one or more GUI elements is selectable via an input at an application interface of the computing device. The method further includes determining that the user has selected a particular prompt suggestion of the prompt suggestions via the application interface of the computing device; causing content of the particular prompt suggestion to be incorporated into a generative model input to be provided to one or more of the generative models; and causing the application to render one or more additional GUI elements that characterize multiple different additional prompt suggestions. Each additional GUI element of the one or more additional GUI elements is selectable via an additional input at the application interface of the application. The method further includes determining that the user has selected an additional particular prompt suggestion of the additional prompt suggestions via the application interface of the computing device; and causing the application to output generative content based on at least the particular prompt suggestion and the additional particular prompt suggestion.

These and other implementations of technology disclosed herein can optionally include one or more of the following features.

In some implementations, causing the application to render the one or more additional GUI elements can include causing each particular GUI element of the one or more additional GUI elements to be rendered with a respective feature that the user can access via the application interface of the computing device. The application interface can include one or more different application interfaces.

In some versions of those implementations, each respective feature can be different for each particular GUI element of the one or more additional GUI elements.

In some further versions of those implementations, each respective feature can correspond to a visual feature that distinguishes a compatibility of each particular GUI element relative to the additional particular prompt suggestion.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform operations of any of the aforementioned methods. Some implementations also include a computer program product including instructions executable by one or more processors to perform operations of any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

We claim:

1. A method implemented by one or more processors, the method comprising:
receiving an input at an application interface that is being rendered by a computing device that provides access to an application,
wherein the input is provided in furtherance of causing the application to output generative content using one or more generative models;
determining, based on the input at the application interface, prompt suggestions to suggest for processing with the input to generate the generative content,
wherein the prompt suggestions are determined using the one or more generative models and/or one or more other models;
causing the application to render one or more graphical user interface (GUI) elements that characterize multiple different prompt suggestions of the prompt suggestions,
wherein each GUI element of the one or more GUI elements is selectable via an additional input at the application interface of the computing device;
determining that a user has selected a particular prompt suggestion of the prompt suggestions via the application interface of the computing device,
wherein the application interface provides an indication that the user selected the particular prompt suggestion for processing with the input received at the application interface; and
causing the application to output the generative content based on at least the particular prompt suggestion and the input received at the application interface.

2. The method of claim 1, wherein determining the prompt suggestions includes:
determining a compatibility metric for the particular prompt suggestion based on a degree of compatibility between the input and the particular prompt suggestion,
wherein a particular GUI element for the particular prompt suggestion is rendered with a feature that is based on the compatibility metric.

3. The method of claim 2, wherein the determining the compatibility metric for the particular prompt suggestion includes:
determining a degree of compatibility by comparing embedding classifiers generated for the input and the particular prompt suggestion,
wherein the compatibility metric is based on the degree of compatibility.

4. The method of claim 2, wherein the feature is a visual feature, and, when the compatibility metric satisfies a threshold value, the visual feature appears visibly different from another feature of another GUI element of the one or more GUI elements rendered at the application interface.

5. The method of claim 2, wherein the feature is a dynamic feature exhibited by the particular GUI element, or a device interface, when the user interacts with the application interface to cause the particular prompt suggestion to be processed with the input.

6. The method of claim 5, wherein the dynamic feature is a positive or negative attraction to an input GUI element, and the dynamic feature is exhibited when the input is received at the application interface.

7. The method of claim 6, wherein the degree of attraction is exhibited by the particular GUI element when the user performs a drag-and-drop gesture to change a proximity of the particular GUI element relative to the input GUI element.

8. The method of claim 6,
wherein the input GUI element is an available prompt suggestion provided by the application and selected by the user, and
wherein the input is received when the user selects the available prompt suggestion by interacting with the interface of the computing device.

9. The method of claim 1, wherein causing the application to output the generative content includes:
causing the application interface to include an interactive GUI element for adjusting a degree to which the particular prompt suggestion affects the generative content.

10. The method of claim 1, further comprising:
causing an updated feature of a separate prompt suggestion of the prompt suggestions to be rendered based on the user selecting the particular prompt suggestion,
wherein the updated feature for the separate prompt suggestion indicates a degree of compatibility of the separate prompt suggestion to the generative content.

11. The method of claim 10,
wherein the input corresponds to a generative text output and the particular prompt suggestion corresponds to a generative image output, and
wherein the updated feature indicates that the separate prompt suggestion is compatible with a generative image or generative text.

12. The method of claim 11, further comprising:
causing the application to provide an initial generative image at the application interface in response to receiving the input,
wherein causing the generative content to be output by the application includes modifying the initial generative image to be generative content that is based on the particular prompt suggestion and the input.

13. A method implemented by one or more processors, the method comprising:
receiving a partial input at an application interface that is being rendered by a computing device that provides access to an application,
wherein the partial input is provided in furtherance of causing the application to output generative content using one or more generative models;
causing the application to render one or more graphical user interface (GUI) elements that characterize multiple different prompt suggestions to add to the partial input,
wherein each GUI element of the one or more GUI elements is selectable via an additional input at the application interface of the computing device;
determining that a user has selected a particular prompt suggestion of the prompt suggestions via the application interface of the computing device,
determining whether the particular prompt suggestion is compatible with the partial input; and
in response to determining that the particular prompt suggestion is not compatible with the partial input:
generating a notification that indicates the particular prompt suggestion is not compatible with the partial input; and
causing the application to output the notification in response to the user selecting the particular prompt suggestion.

14. The method of claim 13, further comprising;
in response to determining that the particular prompt suggestion is not compatible with the partial input:
causing the application to output the generative content based on at least the particular prompt suggestion and the partial input received at the application interface.

15. The method of claim 13, wherein determining whether the particular prompt suggestion is compatible with the partial input includes:
processing the particular prompt suggestion and the partial input using one or more of the generative models to determine whether the particular prompt suggestion and the partial input are compatible; and
determining, based on the output, whether the particular prompt suggestion is compatible with the partial input.

16. The method of claim 13, wherein determining whether the particular prompt suggestion is compatible with the partial input comprises:
causing a classifier, that is in addition to or included in the one or more generative models, to generate output based on processing the particular prompt suggestion and the partial input,
wherein compatibility is determined based on the output.

17. A method implemented by one or more processors, the method comprising:
determining that a user has accessed an application at a computing device that provides access to the application,
wherein the application provides access to one or more generative models;
causing the application to render one or more graphical user interface (GUI) elements that characterize multiple different prompt suggestions,
wherein each GUI element of the one or more GUI elements is selectable via an input at an application interface of the computing device;
determining that the user has selected a particular prompt suggestion of the prompt suggestions via the application interface of the computing device;
causing content of the particular prompt suggestion to be incorporated into a generative model input to be provided to one or more of the generative models;
causing the application to render one or more additional GUI elements that characterize multiple different additional prompt suggestions,
wherein each additional GUI element of the one or more additional GUI elements is selectable via an additional input at the application interface of the application;
determining that the user has selected an additional particular prompt suggestion of the additional prompt suggestions via the application interface of the computing device; and
causing the application to output generative content based on at least the particular prompt suggestion and the additional particular prompt suggestion.

18. The method of claim 17, wherein causing the application to render the one or more additional GUI elements includes:
causing each particular GUI element of the one or more additional GUI elements to be rendered with a respective feature that the user can access via the application interface of the computing device,
wherein the application interface includes one or more different application interfaces.

19. The method of claim 18, wherein each respective feature is different for each particular GUI element of the one or more additional GUI elements.

20. The method of claim 19, wherein each respective feature corresponds to a visual feature that distinguishes a compatibility of each particular GUI element relative to the additional particular prompt suggestion.
